(19) United States
(12) Patent Application Publication
(10) Pub. No.: US 2005/0259226 A1
(43) Pub. Date: Nov. 24, 2005

(54) Methods and apparatuses for presenting an image

(76) Inventors: Thomas J. Gilg, Shedd, OR (US); Lonnie D. Mandigo, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/851,522

(22) Filed: May 20, 2004

(51) Int. Cl. G03B 21/00

(52) U.S. Cl. 353/69

(57) ABSTRACT

A method for presenting an image includes accessing geometry information including a size and shape of an image presentation area, a distance of the image presentation area from a display device generating the image, and an orientation of the image presentation area in relation to the display device, and fitting an image to the image presentation area in response to the geometry information.

### BACKGROUND OF THE INVENTION

Projectors are used to present images on screens and other projection surfaces. Some projectors are equipped with zoom lens and or keystoning capabilities to accommodate screens of different sizes and orientations. Typically, such display devices require adjustments to effect proper sizing and/or keystoning of an image for a given projection surface. For example, a projectionist selects an amount of zoom (or image scaling) to be used by looking at the image as it is being projected and making adjustments until the image is properly sized for a particular projection surface, e.g., a screen in a conference room.

Although many different projectors are currently available, it would be helpful to be able to eliminate the need to have projectionists perform some or all of the aforementioned adjustments. Moreover, it would be desirable to be able to provide methods and apparatuses for projecting images onto a variety of different image presentation areas (e.g., screens, surfaces, displays, etc.) without an undue amount of projectionist or display device user involvement. Additionally, it would be helpful to be able to adjust characteristics of a projected image in response to a variety of considerations including but not limited to spatial relationships between image presentation areas and a display device, changes in these relationships, and the preferences and/or positions of viewers relative to the image presentation areas.

### BRIEF DESCRIPTION OF THE DRAWINGS

Detailed description of embodiments of the invention will be made with reference to the accompanying drawings:

FIG. 1 is a functional diagram of an example apparatus for providing an image according to an embodiment of the present invention;

FIG. 1A illustrates an example of how a display device implementing principles of the present invention can be configured with mechanisms for directing and/or repositioning the display device;

FIG. 2 illustrates an example of how a display device implementing principles of the present invention can be used to provide an image on image presentation areas with different shapes and/or orientations relative to the display device;

FIGS. 3A and 3B illustrate an example of how the principles of the present invention can be used to rotate an image within an image presentation area;

FIGS. 4A and 4B illustrate examples of how the principles of the present invention can be used to fit rectangular images to rectangular image presentation areas;

FIGS. 4C and 4D illustrate examples of how the principles of the present invention can be used to fit rectangular images to non-rectangular image presentation areas;

FIG. 4E illustrates an example of how the principles of the present invention can be used to fit a non-rectangular image to a rectangular image presentation area;

FIG. 4F illustrates an example of how the principles of the present invention can be used to fit a non-rectangular image to a triangular image presentation area;

FIG. 4G illustrates an example of how the principles of the present invention can be used to warp an image in a linear fashion to compensate for a horizontally oblique image presentation area;

FIG. 4H illustrates an example of how the principles of the present invention can be used to warp an image in a nonlinear fashion to compensate for a horizontally oblique image presentation area;

FIG. 4I illustrates an example of how the principles of the present invention can be used to warp an image in a linear fashion to compensate for a vertically oblique image presentation area; and

FIG. 4J illustrates an example of how the principles of the present invention can be used to warp an image in a nonlinear fashion to compensate for a vertically oblique image presentation area.

### DETAILED DESCRIPTION

The following is a detailed description for carrying out embodiments of the invention. This description is not to be taken in a limiting sense, but is made merely for the purpose of illustrating the general principles of the example embodiments of the invention.

According to various embodiments of the present invention, characteristics of a projected image are adjusted in response to one or more considerations including, for example, spatial relationships between image presentation areas and a display device, changes in these relationships, and the preferences and/or positions of viewers relative to the image presentation areas. In one embodiment, a method for presenting an image includes accessing geometry information including a size and shape of an image presentation area, a distance of the image presentation area from a display device generating the image, and an orientation of the image presentation area in relation to the display device, and fitting an image to the image presentation area in response to the geometry information. The process of fitting the image can include zooming, warping and/or rotating the image. Fitting the image according to the present invention can include optically and/or digitally zooming the image, optically and/or digitally warping the image, optically and/or digitally keystoning the image, optically and/or digitally rotating the image, or any combination of these or other image adjusting or processing techniques.

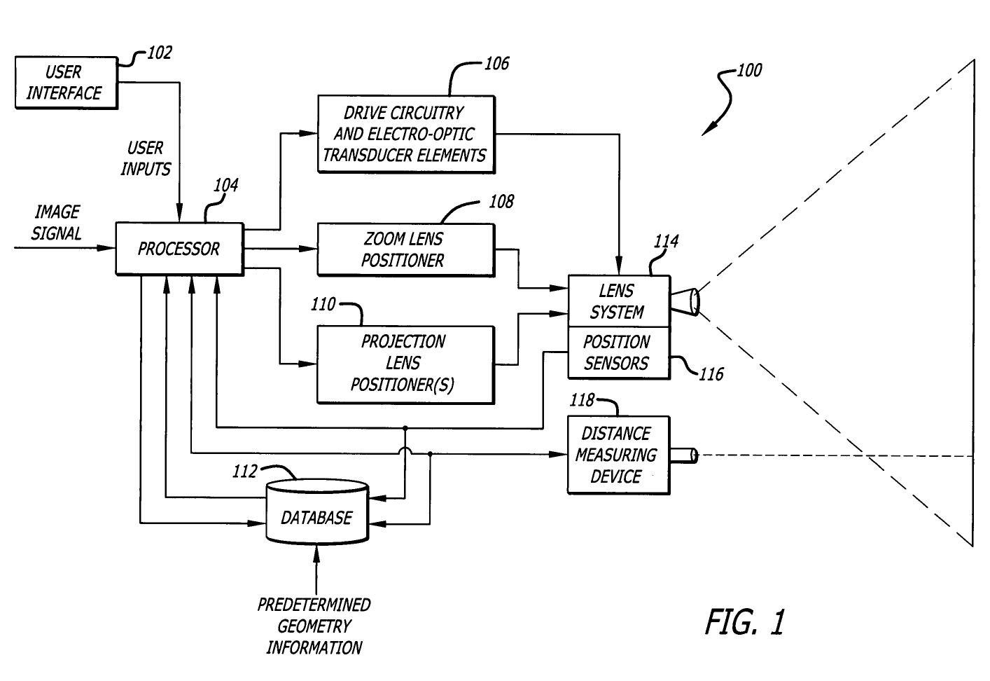

FIG. 1 shows an apparatus for presenting an image according to an example embodiment of the present invention. In this example embodiment, a display device 100 includes a user interface 102, a processor 104, drive circuitry and electro-optic transducer elements 106, a zoom lens positioner 108, projection lens positioner(s) (projection aiming device) 110, a database 112, a lens system (optical system) 114, position sensor(s) 116, and a distance measuring device 118, operatively configured as shown. In various embodiments, the display device 100 includes a digital projector with an optical zoom. In this example embodiment, the geometry information is stored in the database 112 and accessed by the processor 104. By way of example, the geometry information includes the dimensions of all image presentation areas (e.g., projectable surfaces) within a room or other environment, as well as the spatial relationships between the image presentation areas and the display device. In various embodiments, the geometry information includes position information for the image presentation areas and the display device mapped to a three-dimensional (3D) coordinate system. By providing the position information in such a fashion, distances between the image presentation areas and the display device, as well as orientations of the image presentation areas to the display device, can be determined for the database 112. In an example embodiment, the geometry information is predetermined (e.g., extracted from a 3D mapping of a room) and provided (e.g., uploaded) to the database 112. In another example embodiment, the geometry information is at least partially determined from outputs of the distance measuring device 118. Distance measurements are associated with known positions and orientations of the distance measuring device 118 to map or partially map a particular 3D environment. The processor 104 can be configured to receive and process outputs from the position sensor(s) 116 and the distance measuring device 118 to map image presentation areas. Alternatively, processing to determine the geometry information can be distributed or performed elsewhere (e.g., by a processor within the distance measuring device 118, which would allow outputs of the distance measuring device 118 to be directly provided to the database 112). By way of example, the distance measuring device 118 includes a sensor (such as an optical sensor). The distance measuring device 118 can also include a camera, a laser, or other mechanism for determining distance. For example, a grid can be constructed and a camera used to map it. In various embodiments, the geometry information also includes characteristics of the display device 100 (e.g., resolution and zoom characteristics). An example mechanism for providing geometry information can include a database that is accessible to the display device and/or a distance measuring device. Thus, according to an example embodiment of the present invention, an apparatus for presenting an image includes a display device configured to fit an image to an image presentation area in response to geometry information including a size and shape of the image presentation area, a distance of the image presentation area from the display device, and an orientation of the image presentation area relative to the display device.

The principles of the present invention are also applicable in circumstances where the spatial relationships between the one or more image presentation areas and the display device are changing, e.g., when the image presentation area is moving in relation to the display device, or vice versa. An example mechanism for adjusting the geometry information in response to changes in these spatial relationships includes a distance measuring device as discussed above. By way of example, the processor 104 is programmed to adjust the geometry information in response to changes in spatial relationships between the one or more image presentation areas and the display device.

In this example embodiment, the lens system 114 includes a zoom lens and a projection lens. The zoom lens positioner 108 provides a mechanism for adjusting/positioning the zoom lens, to zoom in or out, in response to commands generated by the processor 104 to effect a zoom adjustment. The projection lens positioners 110 provide a mechanism for positioning the projection lens in relation to the image presentation area and controlling a projection direction for the lens system 114 in response to commands (e.g., projection direction commands) generated by the processor 104. Position sensor(s) 116 are configured in relation to the lens system 114 to provide positional feedback to the processor 104. In this example embodiment, the processor 104 is configured to receive and process an image signal and to provide a processed image signal to the drive circuitry and electro-optic transducer elements 106 which, in turn, provide an optical output to the lens system 114.

FIG. 1A illustrates an example of how a display device implementing principles of the present invention can be configured with mechanisms for directing and/or repositioning the display device. In this example, the lens system 114 is configured with rotational positioning mechanisms 120, 122, 124 and a translational positioning mechanism 126 as shown. The rotational positioning mechanisms 120, 122, 124 and the translational positioning mechanism 126, which include servo controlled motors, for example, are configured and controlled to reposition the lens system 114 by rotational and/or translational movements as indicated by arrows 130, 132, 134 and 136, respectively. In this example, the rotational positioning mechanisms 120 and 122 control elevation and azimuth movements, respectively. The rotational positioning mechanism 124 controls rotation of the projection lens of the lens system 114 about its optical axis. The translational positioning mechanism 126 repositions the entire lens system 114, in this example, along a track 138. It should be appreciated that other mechanisms can be used to direct and/or reposition the lens system 114 as well as other components of the display device 100 according to principles of the present invention.

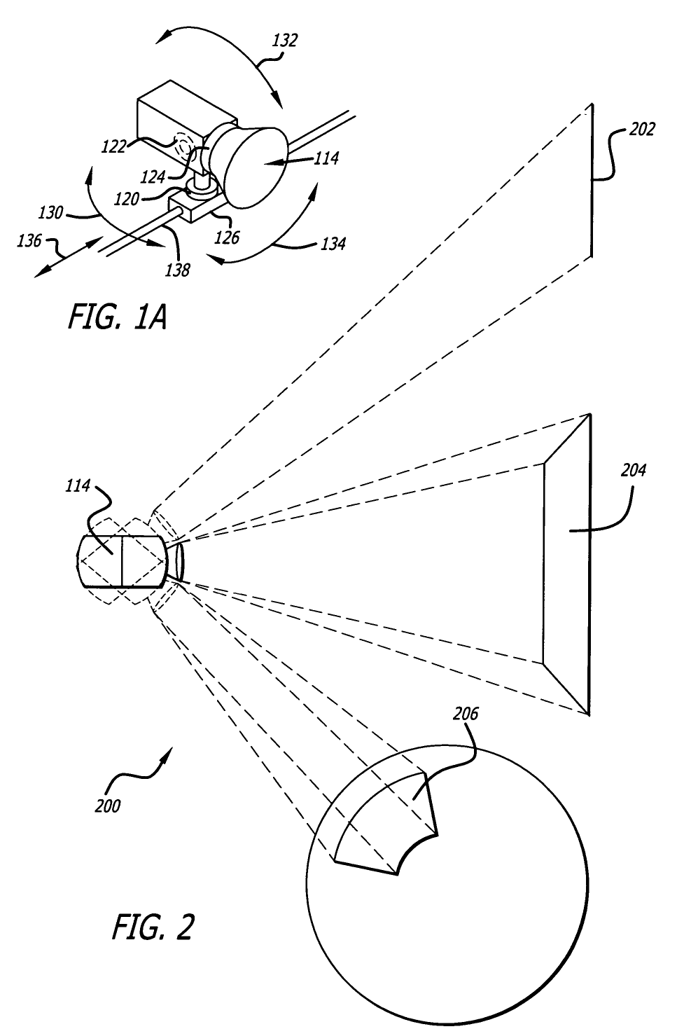

FIG. 2 illustrates an example of how a display device implementing principles of the present invention can be used to provide an image on image presentation areas with different shapes and/or orientations relative to the display device. In this example, an operating environment 200 (e.g., a room) includes image presentation areas 202, 204 and 206. The lens system 114 is shown directed toward each of the image presentation areas 202, 204 and 206. In this example, the optical axis of the projection lens is centrally directed with respect to each of the image presentation areas 202, 204 and 206. The image presentation areas 202 and 204 are flat or substantially planar. The image presentation areas 202 and 204 are oblique, horizontally and vertically, respectively, with respect to the optical axis of the projection lens. The image presentation area 206 is spherical or curved. The image presentation areas can be a surface, screen or and any device that reflects or responds to optical energy. The image presentation areas can be flat, curved, rectangular, non-rectangular, circular or other shapes. By way of example, the methods and apparatuses of the present invention can be used to display art, virtual wallpaper or other images (on walls), games (on displays or table tops), advertisements or other information (on billboards, signage, or displays).

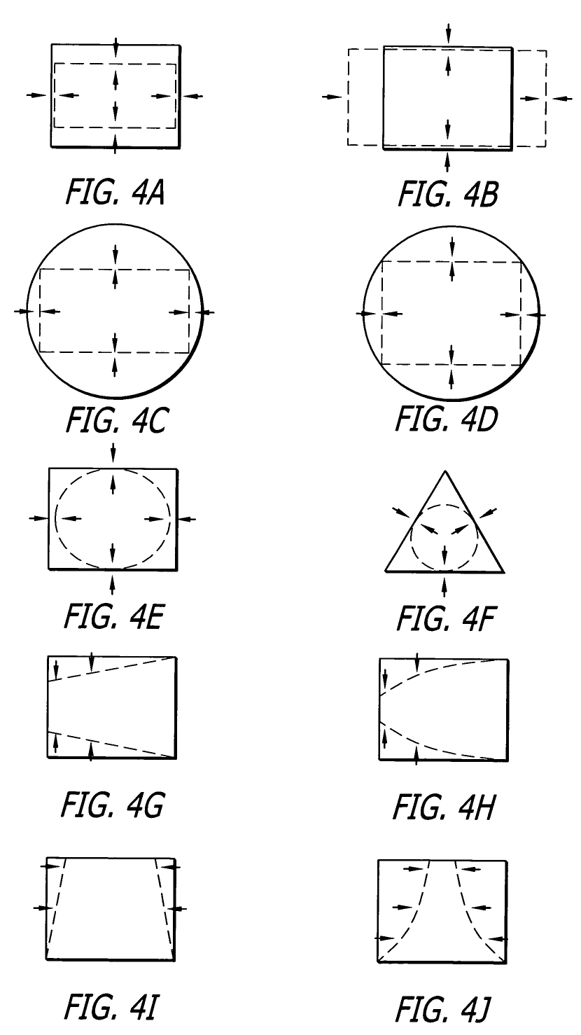

The methods and apparatuses of the present invention are applicable when the image has a shape that is the same as the shape of the image presentation area, as well as when the image has a shape that is different from the shape of the image presentation area. In various embodiments of the present invention, an image is fitted to an image presentation area. By way of example, in FIG. 4A, a rectangular image with a 16:9 aspect ratio (shown in dashed lines) is fitted to a rectangular image presentation area with a 4:3 aspect ratio (shown in solid lines). In this example, the image is zoomed to a maximum size that can be fitted to the image presentation area while keeping all (or most) of the image pixels within the image presentation area. This approach maximizes image resolution without losing significant portions of the image. In FIG. 4B, the rectangular image (shown in dashed lines) is fitted to the image presentation area in a different way. Rather, the rectangular image is zoomed to a maximum sized that can be fitted vertically within the rectangular image presentation area even though side portions of the image extend beyond the image presentation area. In other embodiments, the image is zoomed (or scaled) to the smallest size possible that will cover the target image presentation area. In various embodiments of the present invention, a projector is configured to employ optical scaling or zooming to correlate a bounding box of the projector with a boundary of a projection surface or other image presentation area. It should be appreciated that various criteria can be used to determine how much optical zoom is to be used for presenting a particular image at a particular image presentation area. Moreover, the present invention is not limited to using only optical zoom; digital zooming or scaling can also be used.

Referring again to FIG. 1, in this example embodiment, the processor 104 is an image processor. The processor 104 is configured (programmed) to process the geometry information and to adjust a resolution of the image in relation to the image presentation area. In various embodiments, the processor 104 is configured to scale, warp, keystone and/or rotate the image in relation to the image presentation area. In this example embodiment, the display device 100 also includes a user interface 102 configured to allow a user of the display device 100 to provide a zoom control input, a keystone control input, a projection direction control input and/or an image rotation control input. These and other control inputs can be used to supplement or override commands generated by the processor 104. For example, a user/projectionist may wish to temporarily zoom in on an image area of interest, compensate for an unexpected change in an image presentation area, present an image on a new image presentation area for which complete geometry information is not known, rotate an image to a requested orientation, etc.

As mentioned above, the methods and apparatuses of the present invention are also applicable when the image has a shape that is different from the shape of the image presentation area. By way of example, in FIG. 4C, a rectangular image with a 16:9 aspect ratio (shown in dashed lines) is fitted to a circular image presentation area (shown in solid lines). In this example, the image is zoomed to a maximum size that can be fitted to the image presentation area while keeping all (or most) of the image pixels within the image presentation area. Similarly, in FIG. 4D, a rectangular image with a 4:3 aspect ratio (shown in dashed lines) is fitted to a circular image presentation area (shown in solid lines). It should also be appreciated that the principles of the present invention are not limited to presenting rectangular images. By way of example, in FIG. 4E, a circular image (shown in dashed lines) is fitted to a rectangular image presentation area with a 4:3 aspect ratio (shown in solid lines). In FIG. 4F, a circular image (shown in dashed lines) is fitted to a triangular image presentation area (shown in solid lines). The principles of the present invention can also be applied to other image and image presentation area shape combinations.

In various embodiments, the process of fitting an image to the image presentation area in response to the geometry information includes first using an optical zoom to fit the image to the image presentation area (e.g., taking into consideration the size, shape and orientation of the image presentation area) and then applying digital warping to the image. Digital warping according to the present invention can include a variety of different image processing techniques. In some embodiments, an image is “pre-distorted” to compensate for distortion of the image that would have been caused by the obliqueness and/or non-planar shape of the image presentation area. By way of example, and referring again to FIG. 2, the image presentation area 202 is horizontally oblique in relation to a principal plane of the lens system 114. In this example, digital warping or keystoning can be applied to the image to compensate for the oblique angle formed by the optical axis of the lens system 114 and the image presentation area 202. FIG. 4G illustrates how a rectangular image (shown in solid lines) can be digitally warped (shown in dashed lines) to compensate for distortion of a projected image that would normally occur with the shape and obliqueness of the image presentation area 202. Without the digital warping, projected light would expand to create a larger sized image at the portion of the image presentation area 202 that is further away from the lens system 114. In an additional example, and referring again to FIG. 2, the image presentation area 204 is vertically oblique in relation to a principal plane of the lens system 114. In this example, digital warping or keystoning can be applied to the image to compensate for the oblique angle formed by the optical axis of the lens system 114 and the image presentation area 204. FIG. 41 illustrates how a rectangular image (shown in solid lines) can be digitally warped (shown in dashed lines) to compensate for distortion of a projected image that would normally occur with the shape and obliqueness of the image presentation area 204. Without the digital warping, projected light would expand to create a larger sized image at the portion of the image presentation area 202 that is further away from the lens system 114. Digital warping can be linear or non-linear. By way of example, FIG. 4H illustrates how a rectangular image (shown in solid lines) can be digitally warped in a non-linear fashion (shown in dashed lines) to compensate for distortion that would occur if the image presentation area 202 was also curved (as, for example, the image presentation area 206 is curved). Similarly, FIG. 4J illustrates how a rectangular image (shown in solid lines) can be digitally warped in a non-linear fashion (shown in dashed lines) to compensate for distortion that would occur if the image presentation area 204 was also curved. Digital warping can also be used according to the present invention to make anamorphic adjustments to images. Moreover, image warping according to the present invention can be accomplished using a combination of digital and optical distortion mechanisms.

Thus, according to an example embodiment of the present invention, a method for using a display device includes providing geometry information pertaining to dimensions of one or more image presentation areas, distances between the one or more image presentation areas and a display device, and angles of incidence formed by the one or more image presentation area and image projection paths from the display device to the one or more image presentation area, respectively, and using the geometry information to determine zoom and keystone adjustments for an image generated by the display device and a projection direction for the display device such that the image when projected by the display device fits within and against an image presentation area boundary of a selected one of the image presentation areas. By way of example, the geometry information (predetermined or otherwise) can be a three-dimensional mapping of the one or more image presentation areas in relation to the display device. According to another example embodiment of the present invention, a display device includes a mechanism for providing geometry information pertaining to dimensions of one or more image presentation areas, distances between the one or more image presentation areas and the display device, and angles of incidence formed by the one or more image presentation areas and image projection paths from the display device to the one or more image presentation areas, respectively, and a controller configured to process the geometry information to determine zoom and keystone adjustments for an image generated by the display device and a projection direction for the display device such that the image when projected by the display device fits within and against an image presentation area boundary of a selected one of the image presentation areas.

In various embodiments, the processor (or controller) 104 is configured to process the geometry information and an image rotation input to determine an image orientation adjustment. The projection lens positioner(s) 110 provide a mechanism for positioning a projection lens of the lens system 114 in response to the image orientation adjustment. Alternatively, the processor (or controller) 104 is configured to process the image to digitally provide the image orientation adjustment. In various embodiments, the display device 100 is configured to rotate the image by a mechanical rotation of a lens system component and/or by digital image processing.

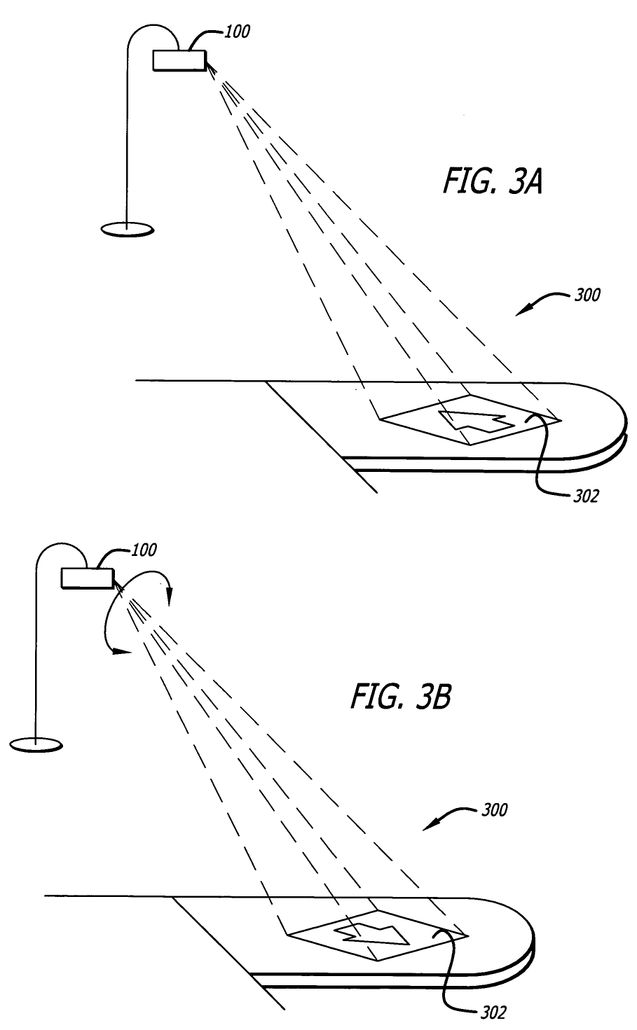

FIGS. 3A and 3B illustrate an example of how the principles of the present invention can be used to rotate an image within an image presentation area. In this example, an operating environment 300 includes a rectangular image presentation area 302 within which an image of an arrow is presented by the display device 100. By way of example, a user/projectionist can control the display device 100 to rotate the image of the arrow within the image presentation area 302 to a desired image orientation. In FIG. 3A, the arrow in the presented image is pointed toward the display device 100. In FIG. 3B, the image has been rotated (mechanically and/or digitally) to change its orientation 1800 such that the arrow in the image is pointed away from the display device 100. In some instances, rotating an image can make it possible to fit a larger number of image pixels within a particular image presentation area.

According to an example embodiment of the present invention, a method for presenting an image includes accessing geometry information including a size and shape of an image presentation area, a distance of the image presentation area from a display device generating the image, and an orientation of the image presentation area in relation to the display device, and rotating and (then) fitting an image to the image presentation area in response to the geometry information. According to another example embodiment of the present invention, a method for presenting an image includes providing geometry information including dimensions of and spatial relationships between a plurality of image presentation areas and a projector, using the geometry information to control the projector to optically zoom and digitally warp an image generated by the projector such that the image is fitted to and presented within a boundary of a selected image presentation area of the plurality of image presentation areas, and using the geometry information to control the projector to rotate the image in relation to the selected image presentation area.

In an example embodiment of the present invention, the display device 100 is configured in a “manual set” mode where the user manually zooms the projection lens a desired amount (e.g., such that an image presentation area is fully covered by the projected image), and the user interface 102 is used to store or set this amount of zoom for that particular projection direction. In various embodiments, the display device 100 is configured to allow a user to “recall” set combinations of zoom amounts and projection directions.

In another example embodiment of the present invention, the display device 100 is configured in a “geometry database” mode where the sizes, shapes and locations of potential image presentation areas are recorded in the database 112, along with the zooming/throw, position and left-right, up-down and rotation capabilities of the lens system 114. As discussed above, the processor 104 is configured (programmed) to determined and control image adjustments for each of the image presentation areas in the database 112.

In another example embodiment of the present invention, the display device 100 is configured in a “closed-loop system” mode to employ the distance measuring device 118 as a closed-loop feedback mechanism. By way of example, the display device 100 is configured to display various test patterns on image presentation areas, and a camera is used to determine the maximal extents of the projected light in relation to the test patterns. In this example, the processor 104 is configured (programmed) to determine and control image adjustments guided by camera feedback in relation to the test patterns.

Although the present invention has been described in terms of the example embodiments above, numerous modifications and/or additions to the above-described embodiments would be readily apparent to one skilled in the art. It is intended that the scope of the present invention extends to all such modifications and/or additions.

1. A method for presenting an image comprising:
accessing geometry information including a size and shape of an image presentation area, a distance of the image presentation area from a display device generating the image, and an orientation of the image presentation area in relation to the display device; and
fitting an image to the image presentation area in response to the geometry information.

2. The method for presenting an image of claim 1, wherein the orientation is oblique.

3. The method for presenting an image of claim 1, wherein fitting the image includes zooming the image.

4. The method for presenting an image of claim 1, wherein fitting the image includes optically zooming the image.

5. The method for presenting an image of claim 1, wherein fitting the image includes warping the image.

6. The method for presenting an image of claim 1, wherein fitting the image includes digitally warping the image.

7. The method for presenting an image of claim 1, wherein fitting the image includes keystoning the image.

8. The method for presenting an image of claim 1, wherein fitting the image includes digitally keystoning the image.

9. The method for presenting an image of claim 1, wherein fitting the image includes rotating the image.

10. The method for presenting an image of claim 1, further comprising:
rotating the image.

11. The method for presenting an image of claim 1, further comprising:
rotating the image prior to fitting the image.

12. The method for presenting an image of claim 1, wherein the image has a shape that is different from the shape of the image presentation area.

13. The method for presenting an image of claim 1, wherein the image presentation area is planar.

14. The method for presenting an image of claim 1, wherein the image presentation area is curved.

15. The method for presenting an image of claim 1, wherein the image presentation area is rectangular.

16. The method for presenting an image of claim 1, wherein the image presentation area is non-rectangular.

17. The method for presenting an image of claim 1, wherein the image presentation area is circular.

18. An apparatus for presenting an image comprising:
a display device configured to fit an image to an image presentation area in response to geometry information including a size and shape of the image presentation area, a distance of the image presentation area from the display device, and an orientation of the image presentation area relative to the display device.

19. The apparatus for presenting an image of claim 18, wherein the display device is a projector.

20. The apparatus for presenting an image of claim 18, wherein the display device is a digital projector.

21. The apparatus for presenting an image of claim 18, wherein the display device includes an optical system.

22. The apparatus for presenting an image of claim 21, wherein the orientation is relative to a principal plane of the optical system.

23. The apparatus for presenting an image of claim 22, wherein the orientation is oblique.

24. The apparatus for presenting an image of claim 18, wherein the display device includes an optical zoom.

25. The apparatus for presenting an image of claim 24, wherein the geometry information includes a zoom characteristic of the optical zoom.

26. The apparatus for presenting an image of claim 18, wherein the display device includes an image processor.

27. The apparatus for presenting an image of claim 26, wherein the image processor is configured to process the geometry information and to adjust a resolution of the image in relation to the image presentation area.

28. The apparatus for presenting an image of claim 26, wherein the image processor is configured to process the geometry information and to scale the image in relation to the image presentation area.

29. The apparatus for presenting an image of claim 26, wherein the image processor is configured to process the geometry information and to warp the image in relation to the image presentation area.

30. The apparatus for presenting an image of claim 26, wherein the image processor is configured to process the geometry information and to keystone the image in relation to the image presentation area.

31. The apparatus for presenting an image of claim 26, wherein the image processor is configured to process the geometry information and to rotate the image in relation to the image presentation area.

32. The apparatus for presenting an image of claim 26, wherein the image processor is configured to rotate the image in relation to the image presentation area.

33. The apparatus for presenting an image of claim 18, wherein the display device is configured to rotate the image.

34. The apparatus for presenting an image of claim 18, wherein the image has a shape that is different from the shape of the image presentation area.

35. The apparatus for presenting an image of claim 18, wherein the image presentation area is a surface.

36. The apparatus for presenting an image of claim 18, wherein the image presentation area is a screen.

37. The apparatus for presenting an image of claim 18, wherein the image presentation area is planar.

38. The apparatus for presenting an image of claim 18, wherein the image presentation area is curved.

39. The apparatus for presenting an image of claim 18, wherein the image presentation area is rectangular.

40. The apparatus for presenting an image of claim 18, wherein the image presentation area is non-rectangular.

41. The apparatus for presenting an image of claim 18, wherein the image presentation area is circular.

42. A method for presenting an image comprising:
providing geometry information including dimensions of and spatial relationships between a plurality of image presentation areas and a projector; and
using the geometry information to control the projector to optically zoom and digitally warp an image generated by the projector such that the image is fitted to and presented within a boundary of a selected image presentation area of the plurality of image presentation areas.

43. The method for presenting an image of claim 42, wherein the selected image presentation area is oblique in relation to a principal plane of the projector when the projector is directed toward the selected image presentation area.

44. The method for presenting an image of claim 42, further comprising:
using the geometry information to control the projector to rotate the image in relation to the selected image presentation area.

45. The method for presenting an image of claim 42, wherein the image has a shape that is different from the shape of the selected image presentation area.

46. The method for presenting an image of claim 42, wherein the selected image presentation area is planar.

47. The method for presenting an image of claim 42, wherein the selected image presentation area is curved.

48. The method for presenting an image of claim 42, wherein the selected image presentation area is rectangular.

49. The method for presenting an image of claim 42, wherein the selected image presentation area is non-rectangular.

50. The method for presenting an image of claim 42, wherein the selected image presentation area is circular.

51. A method for using a display device comprising:
providing geometry information pertaining to dimensions of one or more image presentation areas, distances between the one or more image presentation areas and a display device, and angles of incidence formed by the one or more image presentation area and image projection paths from the display device to the one or more image presentation area, respectively; and
using the geometry information to determine zoom and keystone adjustments for an image generated by the display device and a projection direction for the display device such that the image when projected by the display device fits within and against an image presentation area boundary of a selected one of the image presentation areas.

52. The method for using a display device of claim 51, wherein the geometry information is predetermined.

53. The method for using a display device of claim 51, wherein the geometry information is a three-dimensional mapping of the one or more image presentation areas in relation to the display device.

54. The method for using a display device of claim 51, further comprising:
adjusting the geometry information in response to changes in spatial relationships between the one or more image presentation areas and the display device.

55. The method for using a display device of claim 51, further comprising:
optically zooming the image to effect the zoom adjustment.

56. The method for using a display device of claim 51, further comprising:
digitally zooming the image to effect the zoom adjustment.

57. The method for using a display device of claim 51, further comprising:
digitally warping the image to effect the keystone adjustment.

58. The method for using a display device of claim 51, further comprising:
positioning the display device to effect the projection direction.

59. A display device comprising:
means for providing geometry information pertaining to dimensions of one or more image presentation areas, distances between the one or more image presentation areas and the display device, and angles of incidence formed by the one or more image presentation areas and image projection paths from the display device to the one or more image presentation areas, respectively; and
a controller configured to process the geometry information to determine zoom and keystone adjustments for an image generated by the display device and a projection direction for the display device such that the image when projected by the display device fits within and against an image presentation area boundary of a selected one of the image presentation areas.

60. The display device of claim 59, wherein the means for providing geometry information includes a database that is accessible to the display device.

61. The display device of claim 60, wherein the database includes predetermined geometry information.

62. The display device of claim 60, wherein the database includes a three-dimensional mapping of the one or more image presentation areas in relation to the display device.

63. The display device of claim 59, wherein the means for providing geometry information includes a distance measuring device.

64. The display device of claim 63, wherein the distance measuring device includes a sensor.

65. The display device of claim 63, wherein the distance measuring device includes an optical sensor.

66. The display device of claim 63, wherein the distance measuring device includes a camera.

67. The display device of claim 63, wherein the distance measuring device includes a laser.

68. The display device of claim 59, further comprising:
means for adjusting the geometry information in response to changes in spatial relationships between the one or more image presentation areas and the display device.

69. The display device of claim 68, wherein the means for adjusting the geometry information includes a distance measuring device.

70. The display device of claim 69, wherein the distance measuring device includes a sensor.

71. The display device of claim 69, wherein the distance measuring device includes an optical sensor.

72. The display device of claim 69, wherein the distance measuring device includes a camera.

73. The display device of claim 69, wherein the distance measuring device includes a laser.

74. The display device of claim 59, further comprising:
a zoom lens; and
means for positioning the zoom lens to effect the zoom adjustment.

75. The display device of claim 59, further comprising:
a projection lens; and
means for positioning the projection lens in response to the projection direction.

76. The display device of claim 59, wherein the controller is configured to process the geometry information and an image rotation input to determine an image orientation adjustment.

77. The display device of claim 76, further comprising:
a projection lens; and
means for positioning the projection lens in response to the image orientation adjustment.

78. The display device of claim 76, wherein the controller is configured to process the image to digitally provide the image orientation adjustment.

79. The display device of claim 59, further comprising:
a user interface configured to allow a user of the display device to provide a zoom control input.

80. The display device of claim 59, further comprising:
a user interface configured to allow a user of the display device to provide a keystone control input.

81. The display device of claim 59, further comprising:
a user interface configured to allow a user of the display device to provide a projection direction control input.

82. The display device of claim 59, further comprising:
a user interface configured to allow a user of the display device to provide an image rotation control input.
